(19) United States
(12) Patent Application Publication
(10) Pub. No.: US 2018/0204677 A1
(43) Pub. Date: Jul. 19, 2018

(54) MAGNET

(71) Applicant: Dyson Technology Limited, Wiltshire (GB)

(72) Inventor: Tuncay CELIK, Swindon (GB)

(73) Assignee: Dyson Technology Limited, Wiltshire (GB)

(21) Appl. No.: 15/742,456

(22) PCT Filed: Jun. 29, 2016
(86) PCT No.: PCT/GB2016/051944

§ 371 Date: Jan. 5, 2018

(30) Foreign Application Priority Data
Jul. 6, 2015 (GB) 1511821.9

(51) Int. Cl. H01F 41/02; H01F 1/057; C22C 38/00; C22C 33/02

(52) U.S. Cl. CPC H01F 41/0293; H01F 1/0577; C22C 2200/04; C22C 33/025; C22C 38/005

(57) ABSTRACT

Magnets and systems, methods, and techniques for manufacturing magnets are provided. In some embodiments, methods of manufacturing magnets comprise providing a rare earth magnetic body, cold spray depositing a layer of dysprosium or terbium onto the magnetic body to form a magnet, and heat-treating the magnet. Some embodiments provide a magnet comprising a magnetic body and a layer of dysprosium or terbium. In some embodiments, the magnetic body contains grains of rare earth magnet alloy, and the layer of dysprosium or terbium is deposited onto a surface of the magnetic body by a cold spray process.

### REFERENCE TO RELATED APPLICATIONS

This application is a national stage application under 35 USC 371 of International Application No. PCT/GB2016/051944, filed Jun. 29, 2016, which claims the priority of United Kingdom Application No. 1511821.9, filed Jul. 6, 2015, the entire contents of each of which are incorporated herein by reference.

### FIELD OF THE INVENTION

The present invention relates to rare earth magnets and methods of making rare earth magnets. More specifically, the present invention relates to rare earth magnets with improved coercivity and methods of making the same.

### BACKGROUND OF THE INVENTION

Rare earth magnets may comprise a crystal lattice structure containing grains of rare earth alloys. It has been shown that the magnetic properties, particularly the coercivity, of such magnets can be improved by substituting dysprosium or terbium into the crystal lattice structure. Dysprosium or terbium can be substituted either into the bulk of the crystal lattice, for instance via a binary addition, or along the grain boundaries of the crystal lattice via a heat-treatment step, such as grain boundary diffusion. Diffusion of dysprosium or terbium along the grain boundaries is preferred as less dysprosium or terbium is required to achieve the same improvements in magnetic properties, such as coercivity.

For grain boundary diffusion, dysprosium or terbium must be deposited on the rare earth magnet for effective substitution to occur. The high price and low natural abundance of dysprosium and terbium however has meant that recent research efforts have focused on providing an improved magnet using smaller amounts of dysprosium or terbium. A problem with these deposition techniques is that a considerable amount of time may be required to deposit the dysprosium or terbium, and that wastage of expensive dysprosium or terbium can still occur. It is also considered that some dysprosium containing materials used in current deposition techniques, for example DyF3, may be detrimental to the magnetic properties of the substrate. A method of depositing dysprosium or terbium onto a rare earth magnetic substrate that is fast and/or materially efficient without having a detrimental effect on the magnetic properties of the substrate is desired.

### SUMMARY OF THE INVENTION

According to a first aspect, a magnet includes a magnetic body and a layer of dysprosium; wherein the magnetic body contains grains of a rare earth magnet alloy, and the layer of dysprosium is deposited onto a surface of the magnetic body by a cold spray process.

The grains of rare earth alloy may include magnetic alloys that contain samarium, praseodymium, cerium or neodymium. Of specific interest are sintered alloys containing neodymium or samarium alloys, particularly Nd2Fe14B, SmCo5 and Sm(Co, Fe, Cu, Zr)7.

The use of cold spray to deposit a layer of dysprosium onto the magnetic body has several advantages over conventional techniques. For example, dysprosium metal can be used directly in the process instead of dysprosium rich powders, such as DyF3 or Dy2O3. As mentioned above, fluoride slurries may be detrimental to the magnetic properties of the magnetic substrate. Where a powder rich in Dy2O3 is used, dysprosium oxide can remain after heat-treatment or further sintering of the magnet, leading to inefficient substitution of dysprosium into the lattice structure. These undesired side-effects may be overcome by cold spraying dysprosium metal instead of dysprosium oxides directly onto the magnetic body.

Conventional deposition techniques, such as dysprosium vapour-sorption and dip coating, require a large amount of time and controlled conditions to produce a rare earth magnet with sufficient levels of dysprosium substitution. In contrast, with a cold spray process a less controlled environment is possible and the deposition process is relatively rapid, with dysprosium deposition taking a matter of seconds. Additionally, since standard conditions may be used in cold spray, less of the dysprosium metal is oxidised during processing, thereby providing a better quality of dysprosium for diffusion within the magnetic body.

The amount of dysprosium deposited on the magnetic body can also be carefully controlled and specifically targeted using cold spray. Conventional deposition techniques can lead to unpredictable amounts of deposition and also a high wastage of expensive dysprosium metal that is deposited in the wrong areas.

The magnetic body may be sintered. A sintered magnetic body allows for better grain boundary diffusion to occur. A degree of sintering can take place during the grain boundary diffusion heat-treatment. However it is more beneficial if the magnetic body has been pre-sintered prior to the cold spray deposition of the dysprosium layer. A pre-sintered magnetic body means that a separate heat-treatment step is required for diffusing the dysprosium into the body. This separate heat-treatment step can be carefully tuned so that a grain boundary diffusion is dominant over a full diffusion of dysprosium into the alloy grains.

During heat treatment an amount of dysprosium may be diffused within the grains. A smaller amount of diffused dysprosium can improve the coercivity of the magnetic body compared with increasing the initial amount of dysprosium in the grains. Furthermore, the amount of diffusion can be controlled and tuned by varying the conditions of heat treatment, i.e. temperature ramp up, holding time and temperature, cooling rates and gas atmosphere. The grains may contain an amount of diffused dysprosium of between 0.5 to 15 percent by weight and the dysprosium can be diffused along the boundaries of the grains to form a shell layer.

The grains may comprise a neodymium alloy. Neodymium alloys have a favourable magnetic strength and are widely used in applications where a strong permanent magnet is required. Examples of such applications include electric motors and generators. For some applications the operating temperature can exceed 150° C. The coercivity of conventional neodymium magnets however can suffer at elevated temperatures. It has been found that substituting an amount (typically as much as 12%) of neodymium for dysprosium in the crystal lattice can significantly increase coercivity and improve the performance of the magnet at elevated temperatures. The neodymium alloy may be Nd2Fe14B which exhibits a particularly improved magnet. It is believed that this improvement is due to Dy2Fe14B and (Dy,Nd)2Fe14B having a higher anisotropy field than Nd2Fe14B.

The Nd2Fe14B alloy magnet may comprise grains of Nd2Fe14B with a shell layer comprising Dy2Fe14B or (Dy,Nd)2Fe14B, the shell layer having a thickness of about 0.5 μm. The deposited dysprosium diffuses through the magnetic body during a heat-treatment after depositing the cold sprayed layer of dysprosium on the magnetic body. During the heat-treatment, the deposited dysprosium substitutes with neodymium atoms along the grain boundaries of the crystal lattice, instead of permeating throughout the bulk of the crystal lattice. The shell layer of the grains produced by cold spray and heat-treatment can be much thinner compared to magnets produced by other methods. The shell layer can have a thickness of 0.5 μm. Therefore a much higher concentration of dysprosium is present at the grain boundaries, meaning that less dysprosium is needed to achieve the same coercivity enhancement that is exhibited in conventional dysprosium substituted rare earth magnets.

The deposition thickness of the layer of dysprosium may be between 1 to 5 μm. This thickness results in effective grain boundary diffusion during heat treatment and also reduces wastage of expensive dysprosium. The continuous layer of dysprosium should have an average thickness of 1 to 5 μm since a layer with a uniform thickness is not required.

In a second aspect, the present invention provides a method of manufacturing a magnet, the method comprising: providing a magnetic body containing grains of a rare earth alloy; cold spray depositing a layer of dysprosium onto a surface of the magnetic body to form a magnet; and heat-treating the magnet.

Heat-treating the magnet may comprise a grain boundary diffusion process. More specifically, heat-treating the magnet may comprise: heating the magnet to a first elevated temperature; cooling the magnet to second elevated temperature; and quenching the magnet to room temperature. This process can be conducted such that the first elevated temperature may be at least 900° C. Independent of the first temperature, the second elevated temperature may be at least 500° C. In addition to the temperatures, the magnet may be held at the first elevated temperature for at least 6 hours. Independent of the time that the magnet is held first temperature, the magnet may be held at the second elevated temperature for at least 0.5 hours. These temperatures and times are particularly favoured as they provide good diffusion conditions without the grains undergoing sintering or further sintering.

In a third aspect, the present invention provides a magnet comprising a magnetic body and a layer of terbium; wherein the magnetic body contains grains of a rare earth magnet alloy, and the layer of terbium is deposited onto a surface of the magnetic body by a cold spray process.

In a fourth aspect, the present invention provides a method of manufacturing a magnet, the method comprising: providing a magnetic body containing grains of a rare earth alloy; cold spray depositing a layer of terbium onto a surface of the magnetic body to form a magnet; and heat-treating the magnet.

### BRIEF DESCRIPTION OF THE DRAWINGS

In order that the present invention may be more readily understood, an embodiment of the invention will now be described, by way of example, with reference to the accompanying drawings, in which:

FIG. 1 shows a cross-sectional schematic representation of a magnet according to some embodiments; and

FIG. 2 is a flowchart showing the manufacturing process of the magnet according to some embodiments.

### DETAILED DESCRIPTION OF THE INVENTION

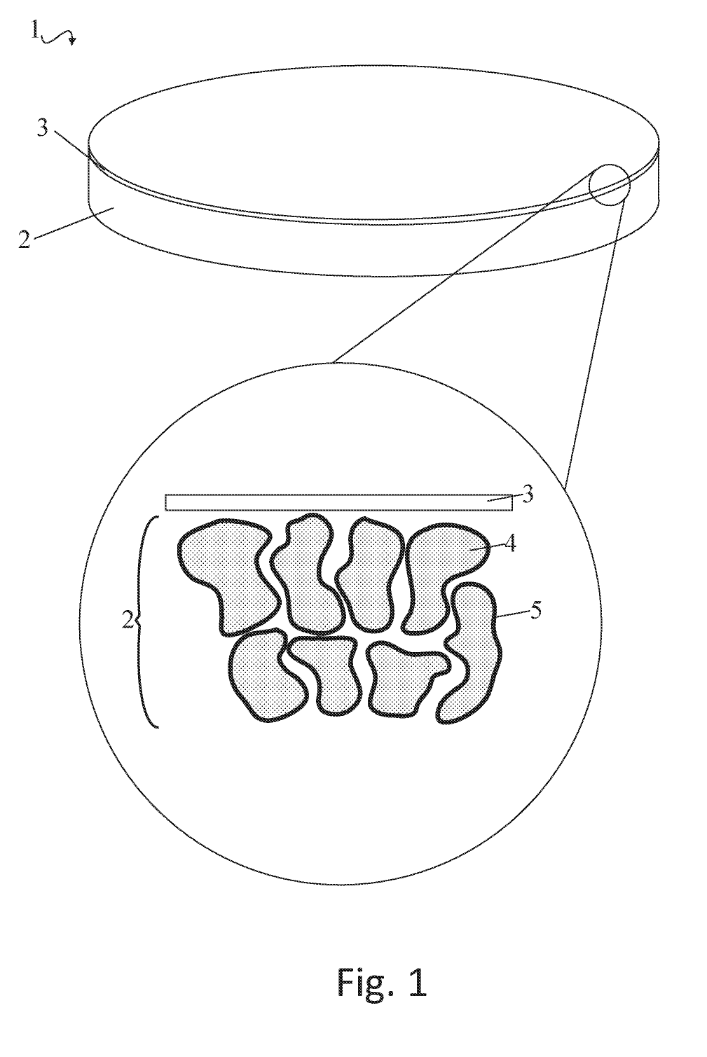

The magnet 1 of FIG. 1 comprises a magnetic body 2 and a layer of dysprosium metal 3 deposited on a surface of the magnetic body 2.

The magnetic body 2 comprises sintered grains 4 of a rare earth alloy. The grains 4 are shown as discrete granules with a boundary. Specifically, the bulk substance within the grains 4 comprises a Nd2Fe14B alloy. The grains 4 adjacent the deposited surface each have a shell layer 5 around their boundary. The shell layer 5 comprises diffused dysprosium which has substituted into the crystal lattice structure of the rare earth alloy. Although dysprosium can diffuse into the bulk of the crystal structure within the grains 4, careful control of the heat treatment conditions allow for diffusion to occur more readily at the grain boundaries. Specifically the shell layer 5 comprises a Dy2Fe14B or (Dy,Nd)2Fe14B alloy where the dysprosium has substituted into the neodymium alloy. The shell layer 5 of dysprosium containing alloy formed around each grain 4 has an approximate thickness of 0.5 μm.

The layer of dysprosium metal 3 is applied directly onto the magnetic body 2 using a cold spray technique. The layer 3 is shown to be uniform and to completely cover the top surface of the magnetic body 2. However, any surface of the magnetic body 2 may have a layer of dysprosium deposited onto it, and the layer 3 can be applied in a uniform or non-uniform manner The thickness of the layer is shown schematically in the figures. A minimum thickness is desired to promote diffusion of dysprosium within or around the grains 4. However, a diminishing return of improved coercivity and magnetic properties is observed past a layer thickness of 5 μm.

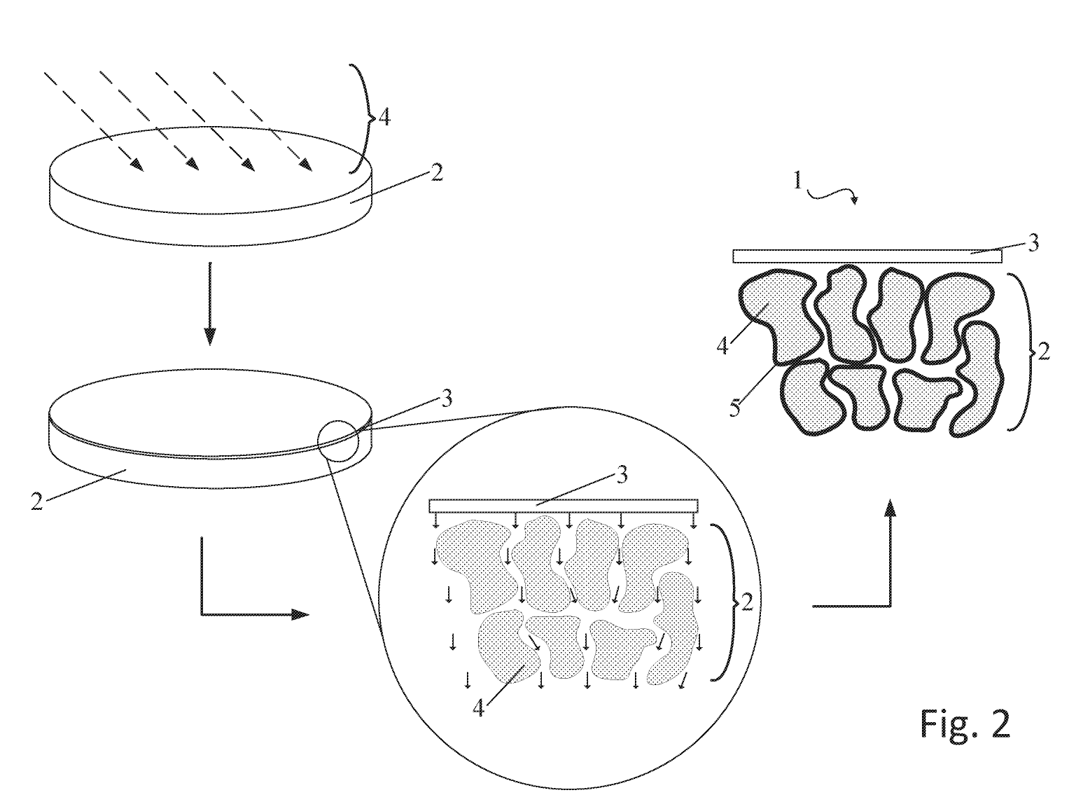

A method of manufacturing the magnet 1 will now be described with reference to FIG. 2. A magnetic body 2 containing grains of a Nd2Fe14B alloy 4 is provided. A surface of the magnetic body 2 is chosen to be coated in dysprosium. Dysprosium metal particles 6 are targeted, discharged and deposited onto the chosen surface. The conditions used for cold spray of other metal powders, such as copper and iron can be applied to the cold spraying of dysprosium metal particles. The deposited dysprosium metal rapidly forms a layer 3 on the targeted surface of the magnetic body 2.

Following the deposition of dysprosium, the magnet 1 is heat treated. During the heat treatment, the shell layer forms around the grains of the magnetic body 2. The heat treatment comprises a grain boundary diffusion process, such that the heat treatment causes dysprosium in the coating layer 3 to diffuse along the boundaries of grains 4 in the magnetic body 2 to form a shell layer 5 containing a dysprosium containing alloy 5. The heat treatment follows the general method of heating the coated magnet 1 at a constant rate to an elevated first temperature and holding the magnet 1 at that elevated temperature for a time period of at least 6 hours. The first elevated temperature should be close to 1000° C., ideally 900° C. This temperature is hot enough to initiate and propagate the diffusion of dysprosium whilst avoiding sintering or melting of the magnetic grains 4.

The magnet 1 is then cooled at a controlled rate to a second elevated temperature which is lower than the first. The magnet 1 is held at this second elevated temperature for less time, around 30 minutes, before it is quenched to room temperature using a controlled cooling rate. The quenched magnet 1 exhibits improved magnetic properties, for example an increased coercivity.

The grains 4 comprise a Nd2Fe14B alloy. The grains can also comprise other magnetic rare earth alloys, such as those containing samarium, praseodymium or cerium, particularly SmCo5 and Sm(Co, Fe, Cu, Zr)7. The diffusion of the dysprosium layer 3 along the boundaries of the alloy grains 4 readily occurs for at least these rare earth alloys.

The grains 4 can be wholly coated in the shell layer 5, as shown in the figures. Alternatively, agglomerated grains 4 can be coated with a shell layer 5, such that the shell layer 5 only covers the exposed boundaries of the grains 4.

Further research has shown that rare earth magnetic metal terbium can also be used in a cold spray deposition process to create a rare earth magnet with improved coercivity.

1. A method of manufacturing a magnet, the method comprising:
providing a magnetic body containing grains of a rare earth alloy;
cold spray depositing a layer of dysprosium onto a surface of the magnetic body to form a magnet; and
heat-treating the magnet.

2. The method of claim 1, wherein heat-treating the magnet comprises a grain boundary diffusion process.

3. The method of claim 1, wherein heat-treating the magnet comprises:
heating the magnet to a first elevated temperature;
cooling the magnet to second temperature; and
quenching the magnet to room temperature.

4. The method of claim 3, wherein the first elevated temperature is at least 900° C.

5. The method of claim 3, wherein the second temperature is at least 500° C.

6. The method of claim 3, wherein the magnet is held at the first elevated temperature for at least 6 hours.

7. The method of claim 3, wherein the magnet is held at the second temperature for at least 0.5 hours.

8. The method of claim 1, wherein the rare earth alloy is a neodymium alloy.

9. The method of claim 8, wherein the neodymium alloy is Nd₂Fe₁₄B.

10. A magnet comprising a magnetic body and a layer of dysprosium; wherein the magnetic body contains grains of a rare earth magnet alloy, and the layer of dysprosium is deposited onto a surface of the magnetic body by a cold spray process.

11. The magnet of claim 10, wherein the magnetic body is sintered.

12. The magnet of claim 10, wherein the rare earth magnet alloy is a neodymium alloy.

13. The magnet of claim in 12, wherein the neodymium alloy is Nd₂Fe₁₄B.

14. The magnet of claim 10, wherein an amount of dysprosium is diffused within the grains.

15. The magnet of claim 14, wherein the grains contain an amount of diffused dysprosium of between 0.5 to 15 percent by weight.

16. The magnet of claim 14, wherein the dysprosium is diffused along the boundaries of the grains to form a shell layer.

17. The magnet of claim 16, wherein the magnetic body comprises grains of Nd₂Fe₁₄B with a shell layer comprising Dy₂Fe₁₄B or (Dy,Nd)₂Fe₁₄B.

18. The magnet of claim 16, wherein the shell layer has a thickness of about 0.5 μm.

19. The magnet of claim 10, wherein the deposition thickness of the layer of dysprosium is between 1 to 5 μm.

20. A method of manufacturing a magnet, the method comprising:
providing a magnetic body containing grains of a rare earth alloy;
cold spray depositing a layer of terbium onto a surface of the magnetic body to form a magnet; and
heat-treating the magnet.

21. The method of claim 20, wherein heat-treating the magnet comprises a grain boundary diffusion process.

22. The method of claim 20, wherein heat-treating the magnet comprises:
heating the magnet to a first elevated temperature;
cooling the magnet to second temperature; and
quenching the magnet to room temperature.

23. The method of claim 22, wherein the first elevated temperature is at least 900° C.

24. The method of claim 22, wherein the second temperature is at least 500° C.

25. The method of claim 22, wherein the magnet is held at the first elevated temperature for at least 6 hours.

26. The method of claim 22, wherein the magnet is held at the second temperature for at least 0.5 hours.

27. The method of claim 20, wherein the rare earth alloy is a neodymium alloy.

28. The method of claim 27, wherein the neodymium alloy is Nd₂Fe₁₄B.

29. A magnet comprising a magnetic body and a layer of terbium; wherein the magnetic body contains grains of a rare earth magnet alloy, and the layer of terbium is deposited onto a surface of the magnetic body by a cold spray process.

30. The magnet of claim 29, wherein the magnetic body is sintered.

31. The magnet of claim 29, wherein the rare earth magnet alloy is a neodymium alloy.

32. The magnet of claim 31, wherein the neodymium alloy is Nd₂Fe₁₄B.

33. The magnet of claim 29, wherein an amount of terbium is diffused within the grains.

34. The magnet of claim 33, wherein the grains contain an amount of diffused terbium of between 0.5 to 15 percent by weight.

35. The magnet of claim 33, wherein the terbium is diffused along the boundaries of the grains to form a shell layer.

36. The magnet of claim 35, wherein the magnetic body comprises grains of Nd₂Fe₁₄B with a shell layer containing terbium.

37. The magnet of claim 35, wherein the shell layer has a thickness of about 0.5 μm.

38. The magnet of claim 29, wherein the deposition thickness of the layer of terbium is between 1 to 5 μm.
